(19) United States
(12) Patent Application Publication
(10) Pub. No.: US 2004/0261826 A1
(43) Pub. Date: Dec. 30, 2004

(54) Roller cover cleaning device and method

(76) Inventor: Khalid M. Budron, Garden Prairie, IL (US)

Correspondence Address: Kejane McManus, P.O. Box 344, Wonder Lake, IL, 60097, US

(21) Appl. No.: 10/603,479

(22) Filed: Jun. 25, 2003

(51) Int. Cl. B08B 3/02

(52) U.S. Cl. 134/152; 134/149; 134/154; 134/170; 134/182; 134/900

(57) ABSTRACT

A device for cleaning roller covers. A spray head has a fluid inlet with a fastener collar and a fluid collection chamber in communication with the fluid inlet defined by a retention wall. A plurality of spray apertures are radially spaced within the retention wall to be adjacent the nap of a roller cover during use. A sealing surface positioned within the radius of the spray apertures seals off an end of the roller cover. A housing having an inner cavity for receiving roller covers has a diameter sized to create cleansing fluid flow through the nap of a roller cover. A plurality of outlet apertures in communication with the inner cavity are radially spaced to be adjacent fibrous portions of a roller cover during use. A drain outlet in communication with the outlet apertures drains fluid from the housing. An outwardly protruding flange about the housing coacts with a fastening ring to tighten the housing against the spray head.

### BACKGROUND OF THE INVENTION

1. Field of the Invention

The claimed invention generally relates to cleaning devices for coating applicators. More specifically, the claimed invention relates to an improved cleaning device for roller covers.

2. Description of the Prior Art

Roller covers placed upon roller frames for application of coatings such as paint and stain to surfaces such as walls, doors and trim have been used for many years. Roller covers have a sleeve surrounded by a fibrous portion, generally called a nap, for absorbing paint or stain that is rolled onto the surface of the wall, door or trim. Upon completion of a particular application of paint or stain to a surface, the roller cover is typically cleaned of excess paint or stain to prevent the paint or stain from drying within the fibrous nap and rendering the roller cover unusable for future use.

In the past, a common way of cleaning a roller cover was to remove a first amount of excess paint or stain by scraping the nap with a rigid instrument such as a putty knife, screw driver, or a tool having an edge with a curve matching the curvature of the roller cover. After the first amount of excess paint or stain had been removed, the roller cover was then generally wrung out by hand while being exposed to a cleaning solution such as water, paint thinner or kerosene.

There have been attempts in the prior art to provide a device that improves the process of cleaning roller covers. An early example of a device for cleaning a roller cover is a device that is generally referred to as a slinger. A slinger generally has a pair of spring arms for frictionally receiving a roller cover that are connected to a manually actuated spinning mechanism that rotates the spring arms and roller cover, effectively “slinging” the paint or stain from the roller cover. This type of device improves the roller cover cleaning process but is very messy in that the fluid held by the nap of the roller cover is discarded radially about the slinger during operation of the device.

Other devices have been devised to clean roller covers. U.S. Pat. No. 4,155,230 issued to Lacher discloses a paint roller cleaner having a cylindrical casing that is sized and shaped to receive a paint roller cover. The hollow center of the cover is closed by appropriate plugs and a cleaning fluid is forced into one end of the casing to flow axially through only the absorbent material and out the other end of the casing. Similarly, U.S. Pat. No. 4,380,478 issued to Cooney discloses an open-ended cylindrical casing sized and shaped to receive a paint roller cover with a plug inserted into one end. The cylindrical casing has a closure cap with a connection for supplying pressurized liquid through the casing and a second closure cap having apertures for discharging the liquid. Further, U.S. Pat. No. 6,079,429 issued to Zarich discloses a paint roller cleaner having a generally tubular housing with one open end and a tapered end to join to a faucet coupling adapted to be releasably secured to a water source.

These roller cover cleaners of the prior art have made significant improvements in cleaning roller covers, but there still remains a need for improved devices for cleaning roller covers.

### SUMMARY OF THE INVENTION

To answer the need for an improved device for cleaning roller covers, the claimed invention provides an improved roller cover cleaning device.

An object of the claimed invention is to provide a roller cover cleaning device having an inlet manifold within the spray head for improved roller cover cleaning.

Another object of the claimed invention is to provide a roller cover cleaning device that can accommodate roller covers of varying length.

A further object of the claimed invention is to provide a roller cover cleaning device that can accommodate roller covers of varying diameter.

An even further object of the claimed invention is to provide a roller cover cleaning device that decreases the time required to properly clean a roller cover.

To accomplished these objectives, as well as others that will become apparent after a reading of this specification and viewing the appended drawings, the claimed invention provides an improved device for cleaning roller covers.

The roller cover cleaning device generally comprises a spray head, a housing and a fastening ring. The roller cover cleaning device may also further comprise a bottom spacer, spacer sleeves 60 or multiple housings 70, 80, 90 of differing size.

The spray head has a fluid supply inlet, a collection chamber, inlet apertures, a first sealing surface, a second sealing surface and threads about the perimeter of the spray head that are sized and shaped to engage the fastening ring. The fluid supply inlet as has a threaded collar for connecting the device to a fluid supply such as a hose or faucet. The collection chamber collects fluid entering the device through the fluid supply inlet directing fluid toward the inlet apertures and increases the velocity of the fluid entering the housing. The first sealing surface is connected to the retention wall and is positioned within the radius of the first grouping of inlet apertures for directing fluid flow toward the nap of the roller cover during use. The second sealing surface is positioned to provide a fluid tight seal between the housing and the spray head when the fastening ring is used to tighten the housing to the spray head.

The housing has an inner cavity for receiving roller covers, a plurality of outlet apertures, an inwardly tapered portion, a flange and feet. The housing has an inner cavity with a diameter sized to create cleansing fluid flow through the fibrous or nap portions of a roller cover during use. The length of the inner cavity is sized such that a first end of the roller cover seals against the first sealing surface of the spray head and a second end of the roller cover abuts a bottom wall of the inner cavity during use.

The plurality of outlet apertures are in communication with the inner cavity of the housing radially spaced to be adjacent the nap of a roller cover during use. The inwardly tapered portion is positioned to be adjacent a tapered second end of the roller cover for maintaining the cleansing fluid flow adjacent the tapered second end of the roller cover. The flange surrounding the housing is used to tighten the housing to the spray head. The feet are connected to the housing for standing the housing in an upright position and providing clearance for fluids exiting the housing during use.

The fastening ring has threads for mating relationship with the threads about the perimeter of the spray head for tightening the housing against the spray head. The fastening ring has a central aperture larger than the outer diameter of the housing defining a lip for engagement with the flange of the housing.

Roller covers commonly come in several different standard diameters and lengths. In order to accommodate the variation in diameter and length from one roller cover to another, the claimed invention may also include a bottom spacer, spacer sleeves or multiple housings of varying diameter.

### BRIEF DESCRIPTION OF THE DRAWINGS

FIG. 1. FIG. 1 is an exploded view of the roller cleaner device.

FIG. 2. FIG. 2 is a cross sectional view of the spray head

FIG. 3. FIG. 3 is a plan view of the bottom of the spray head

FIG. 4. FIG. 4 is a cross sectional view of the housing being tightened against the spray head by the fastening ring.

FIG. 5. FIG. 5 is a cross sectional view of the bottom portion of the housing.

FIG. 6. FIG. 6 is a plan view of the bottom interior of the roller cleaner device.

FIG. 7. FIG. 7 is a cross sectional view of the device with an optional bottom spacer member.

FIG. 8. FIG. 8 illustrates how fluid flows through the roller cleaner device.

FIG. 9. FIG. 9 is a cross sectional view of the device with an optional spacer sleeve member.

FIG. 10. FIG. 10 shows the spray head of the claimed invention with a 3 inch inner diameter housing.

FIG. 11. FIG. 11 shows the spray head of the claimed invention with a 2¼ inch inner diameter housing.

FIG. 12. FIG. 12 shows the spray head of the claimed invention with a 2 inch inner diameter housing.

FIG. 13. FIG. 13 shows the device configured as a kit wit a plurality of differently sized housings.

### DETAILED DESCRIPTION OF THE PREFERRED EMBODIMENT

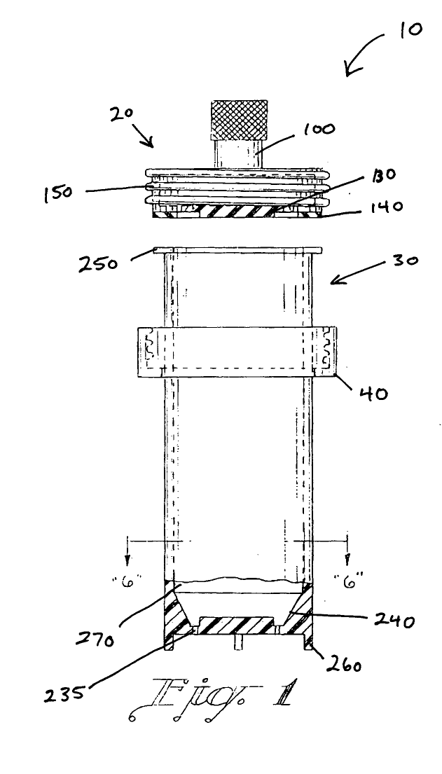

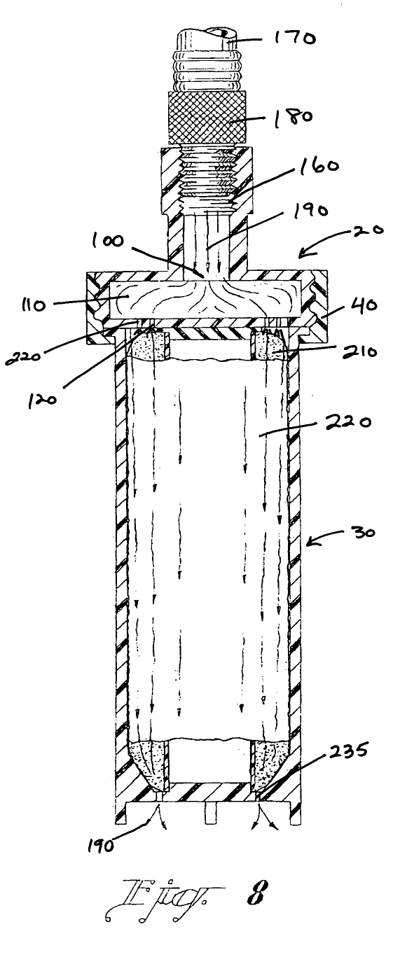

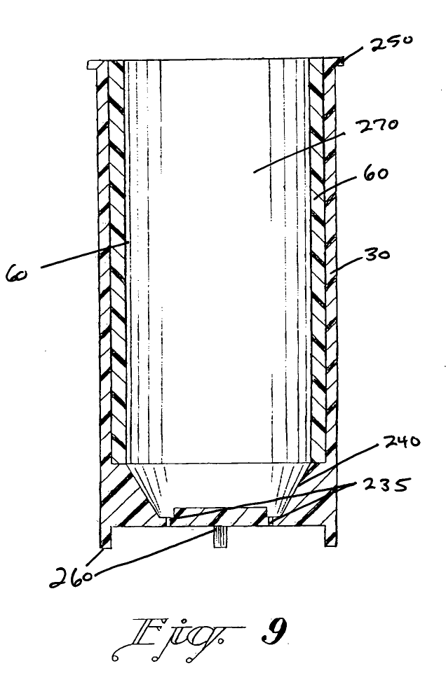

The roller cover cleaning device 10 shown in FIG. 1 generally comprises a spray head 20, a housing 30 and a fastening ring 40. The roller cover cleaning device 10 may also further comprise a bottom spacer 50 as shown in FIG. 7, spacer sleeves 60 as shown in FIG. 9 or multiple housings 70, 80, 90 of differing size as shown in FIG. 13.

The spray head or inlet manifold 20 as shown in FIGS. 1-3 is preferably made of plastic and has a fluid supply inlet 100, a collection chamber 110, inlet apertures 120, a first sealing surface 130, a second sealing surface 140 and threads 150 about the perimeter of the spray head 20 that are sized and shaped to engage the fastening ring 40.

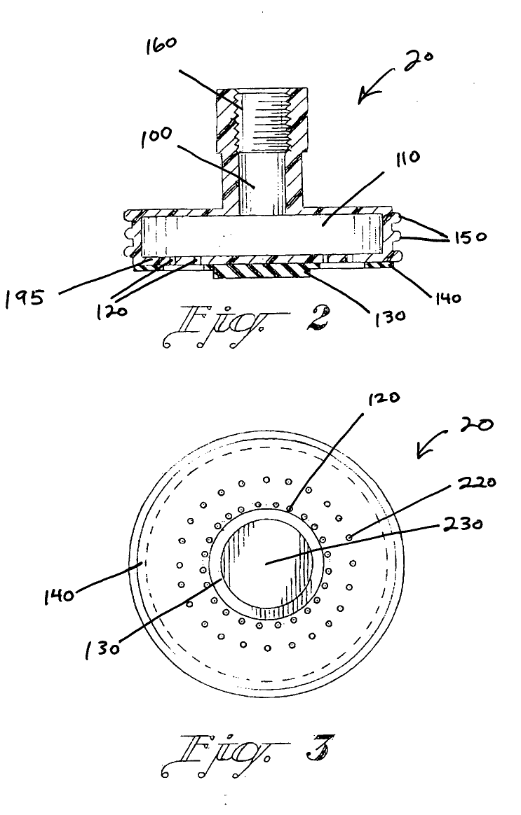

The fluid supply inlet 100 as shown in FIGS. 1-2 has a threaded collar 160 for connecting the device 10 to a fluid supply such as a hose 170 or faucet that is preferably 1 inch in diameter with about a ½ inch interior diameter. The device 10 may also optionally include an optional adapter sleeve 180 for connecting the device 10 to different types of fastening schemes common in fluid conduit connections.

The collection chamber 110 as shown in FIGS. 2 and 8 collects fluid 190 entering the device 10 through the fluid supply inlet 100. The retention wall 195 of the collection chamber 110 directs fluid 190 toward the inlet apertures 120 and increases the velocity of the fluid 190 entering the housing 30 so as to improve the results that are achieved with the roller cleaning device 10 of the claimed invention.

The inlet or spray apertures 120 as shown in FIGS. 2-3 are radially spaced to be adjacent the fibrous or nap portions 200 of the roller cover 210 during use. The first grouping of inlet apertures 120 are radially spaced preferably from about 1⅞ inches to about 2⅛ inches apart about the first sealing surface 130 and are preferably sized from about 1/16 inch to about 3/32 inch in diameter. A second grouping of inlet or spray apertures 220 surrounds the first grouping of spray apertures 120 that are positioned to provide increased fluid flow 225 to the outer portions of the nap 200.

It has been shown through extensive testing that the placement and size of the inlet apertures 120, 220 provide superior results to previous roller cleaning device 10 designs that do not have structure directing fluid flow adjacent the fluid inlet. It is also contemplated that the inlet apertures 120, 220 may be angled inwardly toward a center point 230 of the radial spacing to further augment the performance of the device 10. It is contemplated that the preferred inward angularity of the spray apertures 120, 220 would range from 0 degrees to about 22½ degrees from a vertical orientation. It is even further contemplated that the inlet apertures 120, 220 may be divergently angled with respect to one another to provide increased cleaning efficiency.

The first sealing surface 130, preferably made of a rubber like material, is connected to the retention wall 195 as shown in FIGS. 2-3 and is positioned within the radius of the first grouping of inlet apertures 120 for directing fluid flow 225 toward the nap 200 of the roller cover 210 during use.

The second sealing surface 140, preferably made of a rubber like material, as shown in FIGS. 2-3 is connected to the retention wall 195 of the spray head 20 surrounding the inlet apertures 120. The second sealing surface 140 is positioned to provide a fluid tight seal between the housing 30 and the spray head 20 when the fastening ring 40 is used to tighten the housing 30 to the spray head 20.

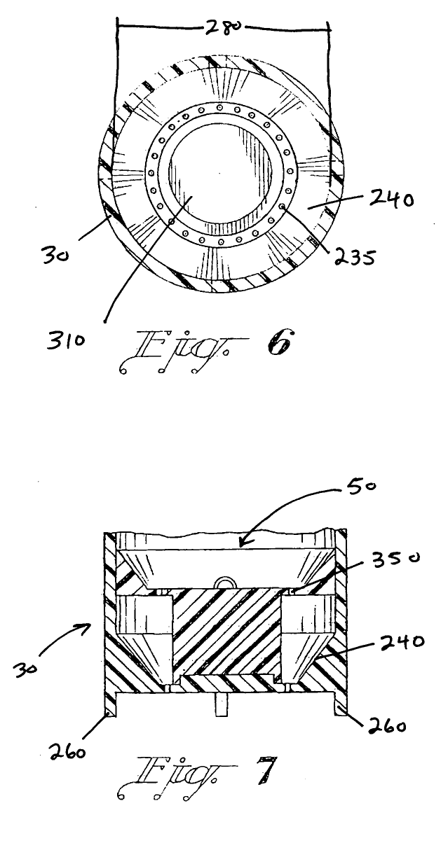

The housing 30 as shown in FIGS. 1, 5 is preferably made of clear plastic about ⅛ inch thick and 8 has an inner cavity for receiving roller covers 210, a plurality of outlet apertures 235, an inwardly tapered portion 240, a flange 250 and feet 260. The housing 30 has an inner cavity 270 with a diameter 280 sized to create cleansing fluid flow 225 through the fibrous or nap portions 200 of a roller cover 210 during use. The length of the inner cavity 260 is sized such that a first end 290 of the roller cover 210 seals against the first sealing surface 130 of the spray head 20 and a tapered second end 300 of the roller cover 210 abuts a bottom wall 310 of the inner cavity 270 during use.

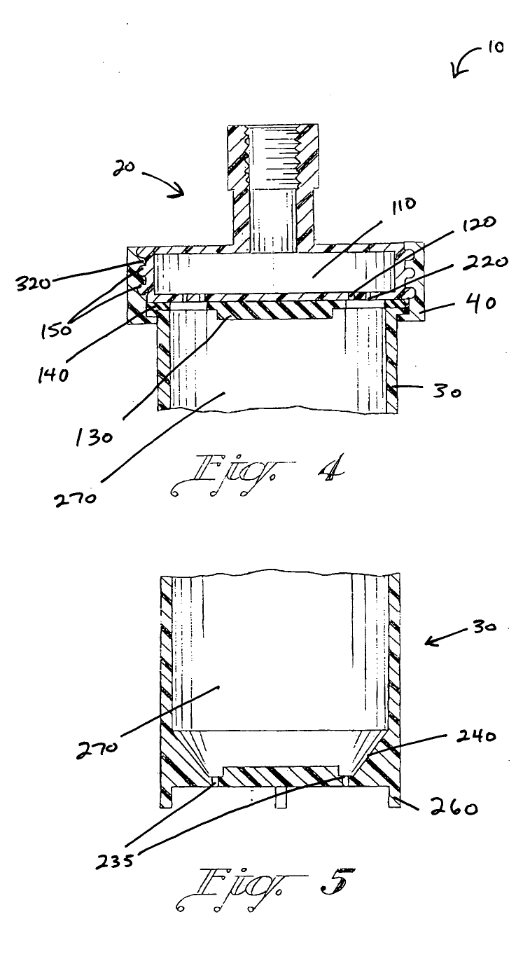

The plurality of outlet apertures 235 as shown in FIGS. 1, 5 and 8 are in communication with the inner cavity 270 of the housing 30 radially spaced to be adjacent fibrous portions 200 of a roller cover 210 during use. The inwardly tapered portion 240 as shown in FIGS. 1, 5 and 8 is positioned to be adjacent a tapered second end 300 of the roller cover 210 for maintaining the cleansing fluid flow 225 adjacent the tapered second end 300. The flange 250 surrounding the housing 30 is used to tighten the housing 30 to the spray head 20 as shown in FIG. 4. Preferably, the flanges250, 400 surrounding the housings 30, 70, 80, 90 are all sized to have an outer diameter of 4 inches. The feet 260 as shown in FIGS. 1 and 8 are connected to the housing 30 for standing the housing 30 in an upright position and providing clearance for fluids 190 exiting the housing 30 during use.

The fastening ring 40 as shown in FIGS. 1 and 4 is preferably made of plastic and has threads 320 for mating relationship with the threads 150 about the perimeter of the spray head 20 for tightening the housing against the spray head 20. The fastening ring 40 has a central aperture 330 larger than the outer diameter of the housing 30 defining a lip 340 for engagement with the flange 250 of the housing 30.

Roller covers commonly come in several different standard lengths. In order to accommodate the variation in length from one roller cover to another, the claimed invention may also include a bottom spacer 50. The bottom spacer 50 as shown in FIG. 7 is preferably made of plastic and is shaped to fit adjacent the tapered second end 300 of the roller cover for accommodating roller covers of varying length. The bottom spacer 50 has structure that is similar to the bottom of the housing 30, having an inwardly tapered portion 240 and a plurality of radially spaced outlet apertures 350. The bottom spacer 50 allows the housing to be sized to receive a 12 inch long roller, will still being able to clean a shorter 9 inch roller cover through use of the bottom spacer 50 maintaining the inner cavity 270 relationships with shorter roller covers.

Roller covers also commonly come in several different standard diameters such as 2 inches, 2¼ inches and 3 inches. In order to accommodate the variation in diameter, the claimed invention may also include spacer sleeves 60 as shown in FIG. 9. The spacer sleeves are preferably made of plastic and are sized for insertion into the inner cavity 270 of the housing 30 when cleaning a smaller diameter roller cover 360 to maintain the cleansing fluid flow 225 through the nap 200 of the roller cover 360.

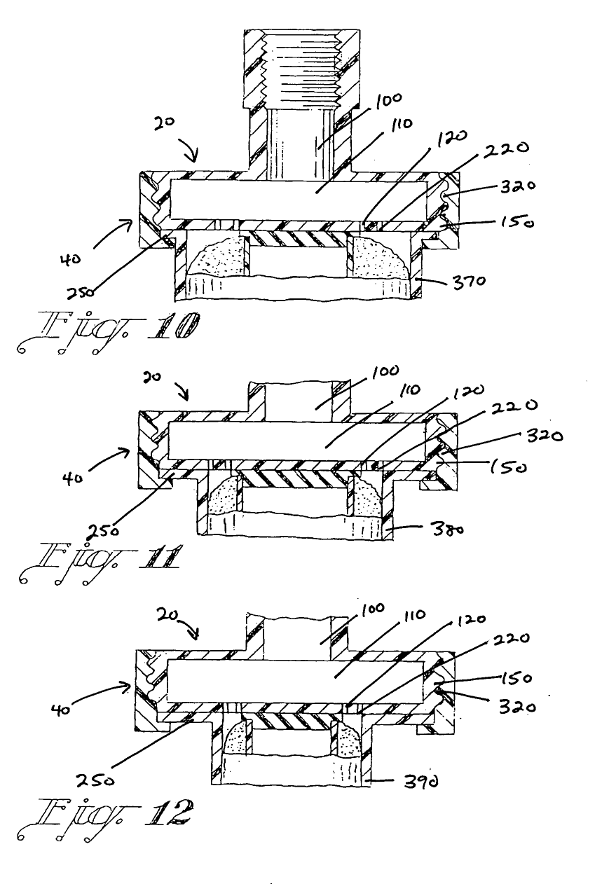

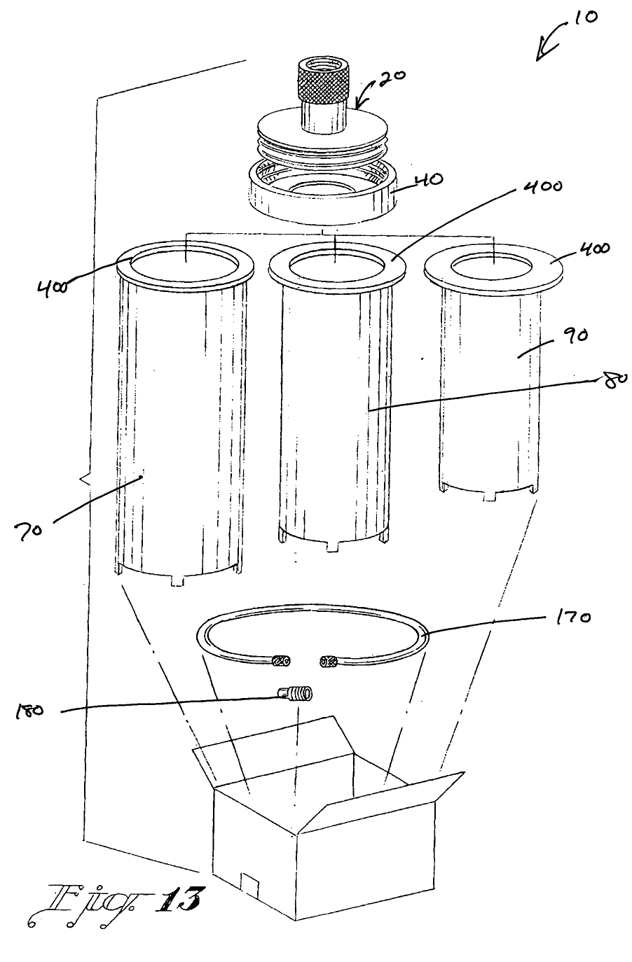

Alternately, the device 10 may include a plurality of plastic housings 30 having inner cavities 370, 380, 390 for receiving roller covers of differing diameter as shown in FIG. 13 that can be sold as a kit that includes an adapter 180 and a length of hose 170. The plurality of housings 70, 80, 90 have differing diameters sized to create cleansing fluid flow through the fibrous portions of the roller covers during use. The flanges 400 about each of the plurality of housings 70, 80, 90 preferably have 4 inch outer diameters so that a single fastening ring 40 can be used to tighten the housings 70, 80, 90 against the spray head 20 as shown in FIGS. 10-12. FIGS. 10-12 further illustrate that the first and second groupings of inlet or spray apertures 120, 220 are positioned in the retention wall 195 of the spray head 20 such that the apertures 120 are not obstructed when being used in housings70, 80, 90 having standard inner diameter sizes such as 2 inches, 2¼ inches and 3 inches.

The device 10 of the claimed invention operates as shown in FIG. 8 where cleansing fluid 190 such as water, paint thinner or kerosene is fed into the device 10 through the fluid supply inlet 100. The cleansing fluid 190 enters the collection chamber 110 where it is directed through the inlet or spray apertures 120 into the inner cavity 270 of the housing 30. The spray apertures 120 perform the dual function of increasing the velocity of the cleansing fluid 190 entering the housing and directing the cleansing fluid flow 225 to the inner nap portions of the roller cover 210 to accomplish through cleaning of a roller cover being cleaned in the device 10. The close proximity of the nap portions 200 to the inner walls of the housing 330 forces the cleansing fluid 190 through the nap portions 200 of the roller cover, cleaning excess material such as paint or varnish from the nap 200. Once the cleansing fluid 190 reaches the bottom of the housing 30, the inwardly tapered portion 240 of the housing 30 directs the cleansing fluid 190 toward the tapered second end 300 of the roller cover 210 to provide through cleaning of the second end 300 of the roller cover 210.

The claimed invention also comprises a method of cleaning a roller cover 210 that is accomplished by the device 10 illustrated in FIG. 8. The device 10 first collects the cleansing fluid 190 in the collection chamber 110 so that the cleansing fluid 190 can be directed into the housing 30 through the inlet apertures 120, 220. The velocity of the cleansing fluid 190 is then increased by concentrating the flow rate of the cleansing fluid 190 entering the device 10 into directed streams through the use of the inlet apertures 120, 220. The inlet apertures 120, 220 also achieve the goal of pointedly directing the cleansing fluid streams 225 toward critical portions of the nap 200, such as those portions 410 immediately adjacent the sleeve 420 of the roller cover 210.

The device 10 then performs the step of guiding the coating material and cleansing fluid 190 toward the tapered end portion of the roller cover 210 by providing an inwardly tapered portion 240 within the housing 30 that is positioned to be adjacent the tapered end portion 300 of the roller cover 210. During testing of the device 10 it was determined that an inwardly tapered portion 240 such as the taper claimed in the invention resulted in increased roller cover cleaning efficiency.

The device 10 also accomplishes the step of maintaining cleansing fluid pressure within the housing 30 by restricting the outlet of the cleansing fluid through the outlet apertures 235 that are radially spaced adjacent the fibrous nap portions 200 of the roller cover 210. Restricting the exit of the cleansing fluid 190 from the housing 30 also increases the cleansing fluid 190 residence time within the housing 30, resulting in improved cleaning efficiency measured in the number of gallons or liters of cleansing fluid 190 required to properly clean a roller cover 210 using a roller cover cleaning device 10 of the type claimed.

Although the invention has been described by reference to some embodiments it is not intended that the novel device be limited thereby, but that modifications thereof are intended to be included as falling within the broad scope and spirit of the foregoing disclosure, the following claims and the appended drawings.

I claim:

1. A device for cleaning roller covers, the device comprising:
an inlet manifold with threads about an outer perimeter having a plurality of inlet apertures radially spaced to be adjacent fibrous portions of a roller cover during use and a fluid supply inlet centrally located adjacent the inlet apertures;
a first sealing surface positioned within the radius of the inlet apertures for directing fluid flow toward the fibrous portions of the roller cover during use;
a housing having an inner cavity for receiving roller covers with a diameter sized to create cleansing fluid flow through the fibrous portions of a roller cover during use and an inwardly tapered portion positioned to be adjacent a tapered second end of the roller cover for maintaining the cleansing fluid flow adjacent the tapered second end;
a plurality of outlet apertures positioned adjacent the inwardly tapered portion of the housing radially spaced to be adjacent fibrous portions of a roller cover during use;
an outwardly protruding flange about the housing; and
a fastening ring having threads for mating relationship with the threads about the outer perimeter of the inlet manifold for tightening the housing against the inlet manifold with a central aperture larger than the inner diameter of the housing defining a lip for engagement with the flange.

2. The device of claim 1 wherein the inner cavity of the housing has a length such that a first end of the roller cover seals against the first sealing surface of the inlet manifold and the tapered second end of the roller cover abuts a bottom wall of the inner cavity during use.

3. The device of claim 2 further comprising a spacer sleeve sized and shaped to fit within and against walls of the inner cavity of the housing.

4. The device of claim 2 further comprising a bottom spacer sized and shaped to fit adjacent the second end of the roller cover for accommodating roller covers of varying length.

5. The device of claim 3 further comprising a second sealing surface connected to the inlet manifold surrounding the inlet apertures positioned to provide a fluid tight seal between the housing and the inlet manifold during use.

6. The device of claim 5 wherein the inlet apertures are radially spaced from about 1⅞ inches to about 2⅛ inches apart.

7. The device of claim 6 wherein at least one of the inlet apertures are angled inwardly toward a center point of the radial spacing.

8. The device of claim 4 further comprising a threaded collar connected to the inlet manifold axially aligned with the supply inlet for connecting the inlet manifold to a fluid supply.

9. The device of claim 8 further comprising at least one foot portion connected to the housing for standing the housing in an upright position providing clearance for fluids exiting the housing during use.

10. A spray head for cleaning roller covers, the head comprising:
a fluid supply inlet having a fastener collar for fastening to a fluid supply;
a fluid collection chamber in communication with the fluid supply inlet defined by a retention wall;
threads about an outer perimeter of the fluid collection chamber;
a plurality of radially spaced spray apertures through the retention wall;
a first sealing surface positioned within the radius of the spray apertures sized to substantially seal off an end of a roller cover during use;
a second sealing surface connected to the retention wall surrounding the spray apertures positioned to provide a fluid tight seal between the retention wall and a lip of a housing during use; and
a fastening ring having a central aperture for receiving a roller cleaner housing and threads for mating relationship with the threads about the fluid collection chamber for tightening a housing against the second sealing surface during use.

11. The head of claim 10 wherein the at least one of the spray apertures are angled inwardly toward a center point of the radial spacing.

12. The head of claim 10 wherein the spray apertures are radially spaced from about 1⅞ inches to about 2⅛ inches apart.

13. The head of claim 12 wherein the spray apertures are from about 1/16 inch to about ⅛ inch in diameter.

14. The head of claim 13 wherein the spray apertures are about 3/32 inch in diameter.

15. A device for cleaning roller covers, the device comprising:
a spray head having a fluid supply inlet with a fastener collar for fastening to a fluid supply;
a fluid collection chamber within the spray head in communication with the fluid supply inlet defined by a retention wall;
threads about an outer perimeter of the spray head;
a plurality of spray apertures radially spaced to be adjacent fibrous portions of a roller cover during use;
a first sealing surface positioned within the radius of the spray apertures sized to substantially seal off an end of a roller cover during use;
a housing having an inner cavity for receiving roller covers with a diameter sized to create cleansing fluid flow through the fibrous portions of a roller cover during use and an inwardly tapered portion positioned to be adjacent a tapered second end of the roller cover for maintaining the cleansing fluid flow adjacent the tapered second end;
a plurality of outlet apertures positioned adjacent the inwardly tapered portion of the housing radially spaced to be adjacent the fibrous portions of a roller cover during use;
an outwardly protruding flange about the housing; and
a fastening ring having a central aperture for receiving the housing and threads for mating engagement with the threads about the perimeter of the spray head for tightening the housing against the retention wall.

16. The device of claim 15 further comprising a second sealing surface connected to the retention wall surrounding the spray apertures positioned to provide a fluid tight seal between the housing and the spray head during use.

17. The device of claim 16 wherein at least one of the spray apertures are angled inwardly toward a center point of the radial spacing.

18. The device of claim 15 wherein the spray apertures are radially spaced from about 1⅞ inches to about 2⅛ inches apart.

19. The device of claim 18 wherein the inner cavity of the housing has a length such that a first end of the roller cover seals against the first sealing surface and the tapered second end of the roller cover abuts a bottom wall of the inner cavity during use.

20. The device of claim 19 further comprising at least one foot portion connected to the housing for standing the housing in an upright position providing clearance for fluids exiting the housing during use.

21. A roller cleaning kit, the kit comprising:
a spray head having a fluid supply inlet with a fastener collar for fastening to a fluid supply;
a fluid collection chamber within the spray head in communication with the fluid supply inlet defined by a retention wall;
threads about an outer perimeter of the spray head;
a plurality of spray apertures radially spaced to be adjacent fibrous portions of a roller cover during use;
a first sealing surface positioned within the radius of the spray apertures sized to substantially seal off an end of a roller cover during use;
a plurality of housings having inner cavities for receiving roller covers of differing diameter, the plurality of housings having differing diameters sized to create cleansing fluid flow through the fibrous portions of the roller covers during use and an inwardly tapered portion positioned to be adjacent a tapered second end of the roller cover for maintaining the cleansing fluid flow adjacent the tapered second end;
an outwardly protruding flange about each of the plurality of housings having substantially similarly sized outer diameters; and
a fastening ring having a central aperture for receiving the housings and threads for mating engagement with the threads about the perimeter of the spray head for tightening the housings against the retention wall.

22. The device of claim 21 further comprising a second sealing surface connected to the retention wall surrounding the spray apertures positioned to provide a fluid tight seal between the housing and the spray head during use.

23. The device of claim 22 wherein at least one of the spray apertures are angled inwardly toward a center point of the radial spacing.

24. The device of claim 21 wherein the spray apertures are radially spaced from about 1⅞ inches to about 2⅛ inches apart.

25. The device of claim 24 wherein the inner cavities of the housings have a length such that a first end of the roller cover seals against the first sealing surface and the tapered second end of the roller cover abuts a bottom wall of the inner cavity during use.

26. The device of claim 25 further comprising at least one foot portion connected to the housing for standing the housing in an upright position providing clearance for fluids exiting the housing during use.

27. A method of cleaning a roller cover, the method comprising:
collecting cleansing fluid in a collection chamber adjacent a fluid supply inlet;
increasing inlet velocity of the cleansing fluid into a housing for cleaning roller covers by concentrating the cleansing fluid flow through radially spaced inlet apertures, the inlet apertures directing the cleansing fluid to inner nap portions of a roller cover;
guiding the cleansing fluid toward tapered end portions of the roller cover by tapering inner cavity portions of the housing adjacent the tapered end portion of the roller cover; and
maintaining cleansing fluid pressure within the housing by restricting cleansing fluid exit from the housing through radially spaced outlet apertures.

28. The method of claim 27 further comprising increasing cleansing fluid residence time within the housing by restricting cleansing fluid exit from the housing through the radially spaced outlet apertures.
